(19) United States
(12) Patent Application Publication
(10) Pub. No.: US 2023/0055703 A1
(43) Pub. Date: Feb. 23, 2023

(54) PACKET PROCESSING WITH PER FLOW HASH KEY SELECTION

(71) Applicant: Intel Corporation, Santa Clara, CA (US)

(72) Inventors: Andrey CHILIKIN, Limerick (IE); Vladimir MEDVEDKIN, Limerick (IE); Elazar COHEN, Haifa (IL)

(21) Appl. No.: 17/983,197

(22) Filed: Nov. 8, 2022

(51) Int. Cl. H04L 49/00; H04L 45/7453; H04L 49/9047

(52) U.S. Cl. CPC H04L 49/3063; H04L 45/7453; H04L 49/9047

(57) ABSTRACT

An apparatus is described. The apparatus includes queue assignment circuitry. The queue assignment circuitry includes first circuitry to select amongst multiple hash keys and second circuitry to hash content of a packet's header with a selected one of the hash keys.

### BACKGROUND

High performance data centers rely on high performance networking infrastructure to efficiently stream packets to/from the data center's respective computing systems. The networking infrastructure is therefore expected to handle the different kinds of packet streams that could flow to and/or from these computing systems.

### FIGURES

FIG. 1 shows a system;

FIGS. 2a and 2b show different types of bi-directional flows;

FIG. 3 shows an improved packet processing pipeline;

FIG. 4 shows another improved packet processing pipeline;

FIG. 5 shows a system having an improved packet processing pipeline;

FIGS. 6, 7, 8 and 9 pertain to processes for specially constructing a hash key and specially selecting header values;

FIG. 10 shows an electronic system;

FIG. 11 shows a data center;

FIG. 12 shows a rack.

### DETAILED DESCRIPTION

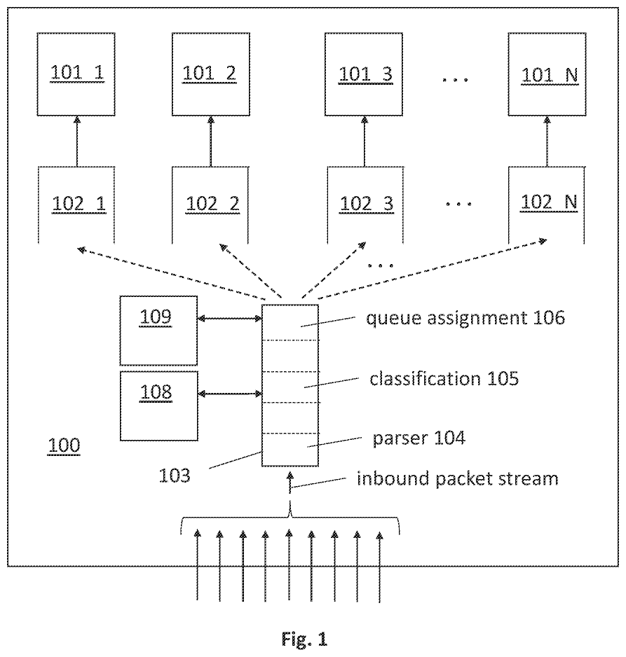

FIG. 1 shows a system 100 (e.g., a computer system, a network system) that transmits/receives packets to/from multiple networks. In various environments the system 100 acts as a nodal hop in between network end-points. The system 100 is configured to handle a number of networking “flows” that flow through the system 100. Here, each flow that flows flow through the system 100 corresponds to a unique combination of packet trafficking characteristics such a source/destination combination, quality of service (QoS), etc.

The system 100 includes a plurality of processing cores 101_1 through 101_N that process the packets of the respective flows in any of a variety of ways. For example, the processing cores 101 can perform network address translation (NAT) for Internet Protocol (IP) related flows (IP address and/or port information is changed for IPv4 flows or IPv4 to IPv6 flows, etc.), security related functions (e.g., that snoop packet payload for harmful content), maintain flow meta data information (e.g., where the meta data for a flow is updated with each next packet that is processed for the flow), etc.

In the particular system 100 of FIG. 1, the processing cores 101_1 through 101_N are coupled to respective inbound queues 102_1 through 102_N. Here, when a received packet is placed in the inbound queue of a particular processing core, the packet (or portion thereof) is processed by the processing core. Likewise, when a particular processing core has completed its processing on a packet, the packet (or portion thereof) is placed in an outbound queue for subsequent transmission (not shown in FIG. 1 for illustrative ease).

When a flow is configured within the system, the flow is effectively assigned to one of the processing cores 101 for processing (e.g., through a technique referred to as receive side scaling (RSS), described in more detail further below). Depending on the nature of the networking service being performed, however, a flow can be indifferent or sensitive as to which particular processing core is assigned to process the flow's packets.

At one extreme (insensitive), the flow can be assigned to any of the processing cores 101_1 through 101_N. An example is NAT where each processor maintains the same translation table. In this case, a newly configured flow will be indifferent to processor assignment (any processor can perform the desired service for the flow).

At another extreme, only one processor is to process a particular flow's packets. An example is a bi-directional “stateful” flow where the component of the flow in one direction (e.g., the downlink flow) is best processed by the same processor that processes the component of the flow in the opposite direction (e.g., the uplink flow). In this case, assignment of both flow components to the same processor allows the processor to more easily maintain the bi-directional flow's state (e.g., meta data) because it directly observes/handles the flows in both directions.

As observed in FIG. 1, a packet processing pipeline 103 is used to process inbound packets and assign each inbound packet to an appropriate queue. Generally, the pipeline 103 includes a stage 104 at (or toward) the pipeline's front end that parses a packet's header and extracts information found in the header's various fields.

The pipeline 103 also includes another stage 105 that identifies the flow that the inbound packet belongs to or otherwise “classifies” the packet for its downstream treatment or handling (“packet classification”). Here, the extracted packet header information (or portion(s) thereof) is compared against entries in a table 108 of looked for values. The particular entry whose value matches the packet's header information identifies the flow that the packet belongs to or otherwise classifies the packet.

The packet processing pipeline 103 also includes a stage 106 at (or toward) the pipeline's back end that, based on the content of the inbound packet's header information (typically the port and IP address information of the packet's source and destination), directs the packet to a particular one of the inbound queues 102_1 through 102_N.

Notably, packets having the same source and destination header information are part of a same flow and will be assigned to the same queue. With each queue being associated with a particular processing core, the forwarding of inbound packets having same source and destination information to a same queue effects the aforementioned assignment of the packets' flow to a particular processor.

In a particular queue assignment approach, referred to as receive side scaling (RSS), an attempt is made to evenly spread the different flows across the different queues 102_1 through 102_N. As such, RSS is particularly suitable for flows that are indifferent to processor assignment. Here, to implement RSS, the queue assignment stage 106 hashes, e.g., the source and destination port and IP address header content of an inbound packet with a hash key (e.g., in the case of RSS for Ethernet packets, a “symmetrical” Toeplitz hash key is often used).

The hashing of an inbound packet's header information with the hash key generates a hash signature. Certain bits from the hash signature, such as a certain number of the hash signature's least significant bits (LSBs), effectively identify the queue that the packet is to be placed in (specifically, the hash signature's LSBs are used as a key into a table 109 having different entries with different queue IDs). Ideally, the respective hash signature LSBs generated from the inbound packets of different flows identify different ones of the input queues evenly.

Complications can arise, however, if the queue assignment stage 106 of the pipeline 103 applies RSS to flows that are sensitive to queue/processor assignment. For example, if RSS is applied to both the uplink and downlink components of a bi-directional stateful flow, the different header content of the uplink packets as compared to the downlink packets could cause the uplink packets to be assigned to one queue/processor and the downlink packets to be assigned to another, different queue/processor.

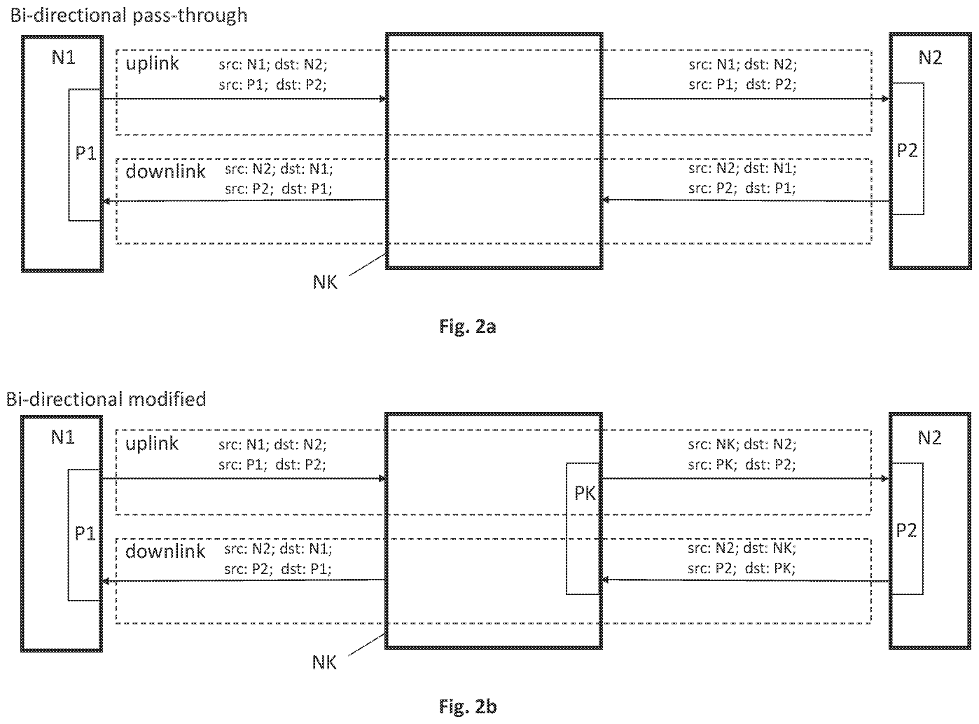

FIGS. 2a and 2b depict two different examples of bi-directional stateful flows. In particular, for reasons explained further below, the flow of FIG. 2a is referred to as a “straight through” flow while the flow of FIG. 2b is referred to as a “modified” flow.

Both flows include an uplink flow and a downlink flow (in both flow examples, the networking system NK is between two nodes N1, N2 that are sending packets to one another). Because the flows of are stateful, they are both sensitive to queue/processor assignment and ideally assign their respective uplink and downlink packets to the same queue so that they can be processed by the same processor. That is, the uplink and downlink packets of the “straight through” flow of FIG. 2a are ideally assigned to a same queue/processor, and, the uplink and downlink packets of the “modified” flow of FIG. 2b are ideally assigned to a same queue/processor.

If the queue assignment stage of the packet processing pipeline uses a symmetrical Toeplitz hash key when hashing the header information of the uplink and downlink packets, packets having substantially similar header content will be mapped to a same queue. Thus, the ability to successfully assign both uplink and downlink packets to a same queue depends on the relative similarity or dissimilarity of the respective header values of the uplink and downlink packets.

According to the “pass through” bi-directional flow observed in FIG. 2a, the networking system NK merely forwards packets in both directions without changing their source and destination header information. Here, packets sent from node N1 in the uplink direction identify port P1 of node N1 as the source and port P2 of node N2 as the destination, and, packets sent from node N2 in the downlink direction identify port P2 of node N2 as the source and port P1 of node N1 as the destination.

The network system NK, upon receiving the packets from node N1 in the uplink direction, simply retransmits the packets to node N2 without any change in the packet's source or destination network address header fields or port header fields. Similarly, in the down-link direction, upon receiving the packets from node N2, the networking system NK simply retransmits the packets to node N1 without any change in the packet's source or destination network address header fields or port header fields.

As such, the network address and port information in the headers of the uplink and downlink packets contain the same set of network address and port identifier field values (N1, N2, P1 and P2). The destination and source field values, however, are swapped as between uplink and downlink packets to reflect the different source and destination for the different directions.

Here, the common set of network addresses and port identifiers (N1, N2, P1, P2) corresponds to sufficient numeric sameness to cause the symmetrical Toeplitz hashing function to generate hashing signatures for both uplink and downlink packets having a same LSB pattern. That is, even though the network addresses and port identifiers are swapped when comparing the header structures of the uplink and downlink packets, the fact that they include the same set of values causes the underlying mathematics of the Toeplitz hashing function to generate respective hash signatures for both uplink and downlink packets having identical LSB information. As such both uplink and downlink packets are mapped into the same inbound queue and corresponding processor.

By contrast, according to the “modified” flow of FIG. 2b, the networking system NK performs network address translation (NAT) between the N1 and N2 nodes. That is, as observed in FIG. 2b, packets sent from node N1 in the uplink direction identify port P1 of node N1 as the source and port P2 of node N2 as the destination. Upon receiving these packets, the network system NK replaces the source information with information identifying itself (port PK of node NK) and retransmits the modified packets to node N2.

Likewise, in the downlink direction, packets sent from node N2 identify port P2 of node N2 as the source and port PK of node NK as the destination. Upon receiving these packets, the network system NK replaces the source information with information identifying port P2 of node N2.

Notably, unlike the pass through flow of FIG. 2a, in the case of the modified flow of FIG. 2b, a common set of node and port values are not merely swapped to define uplink vs. downlink traffic. Rather, downlink packets received by network system NK have port and network address values (PK, NK) that are not found in the uplink packets received by networking system NK.

Unfortunately, these differences correspond to sufficient mathematical dissimilarity to cause the symmetrical Toeplitz hashing function to generate a hashing signature for uplink packets with an LSB pattern that is different than the LSB pattern in the hashing signature generated for downlink packets. As such the uplink and downlink packets are undesirably mapped to different queues and corresponding processors.

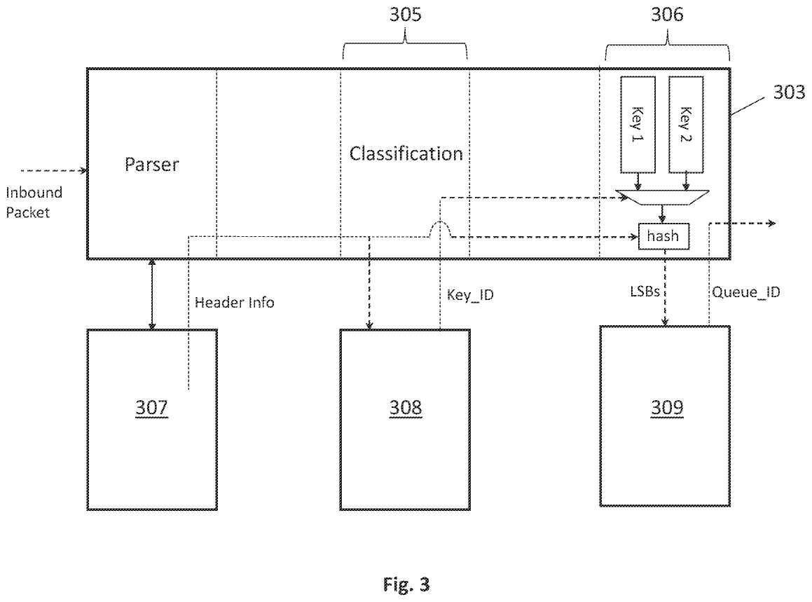

A solution, as observed in FIG. 3, is to construct a queue assignment stage 306 within the packet processing pipeline 303 that applies different hash keys for different types of flows. For example, a symmetrical Toeplitz hash key could be used for: 1) unidirectional flows that are insensitive to processor assignment; 2) both directions of bi-directional flows whose different flow components/directions are insensitive to processor assignment; and, 3) both directions of bi-directional, stateful flows whose different flow components/directions have sufficiently similar header information such that the symmetrical Toeplitz hash key maps them to a same queue (e.g., a straight through, bi-directional stateful flow as in FIG. 2a).

By contrast, the same queue assignment stage 306 applies a specially constructed hash key to bi-directional stateful flows whose different flow components/directions have sufficiently dissimilar header information such that application of the symmetrical Toeplitz hash key would map the respective packets from the different components/directions to different queues (e.g., the modified, bi-directional stateful flow of FIG. 2b). The specially constructed hash key (described in more detail further below) is specially constructed to map the dissimilar header information of both components/directions to a same queue.

As such, the queue assignment stage 306 is designed to be able to apply more than one hash key, where, which hash key is applied depends on the packet's classification (which explicitly or implicitly identifies the packet's flow or type of flow). In an embodiment, the packet classification stage 303 of the pipeline identifies which key to use for the particular packet being processed as part of the packet's classification. The key can be identified outright (keys are given specific IDs and the classification stage identifies the ID of the key to be used), or implicitly, e.g., by identification of the packet's flow type (e.g., pass-through bi-directional stateful vs. modified bi-directional stateful).

The identifier of the key or flow type is passed to the queue assignment stage 306 which, in turn, applies the appropriate key to the packet's header information to generate a hash signature (in the case of flow type based classification, the queue assignment stage could be pre-configured to apply specific keys to specific flow types).

Thus, referring back to the examples of FIGS. 2a and 2b, the packet processing pipeline would apply the symmetrical Toeplitz hash key (Key_1) for both the uplink and downlink flows of the pass through bi-directional stateful flow of FIG. 2a. By contrast, the packet processing pipeline would apply the specially constructed hash key (Key_2) for both the uplink and downlink flows of the modified bi-directional stateful flow of FIG. 2b.

In various embodiments, as alluded to above, the hash key (Key_2) that is applied to the uplink and downlink packets of the modified bi-directional stateful flow is specially constructed to generate a first hash signature from the specific header content of the uplink packets (N2, P2, N1, P1) and a second hash signature from the specific header content of the downlink packets (NK, PK, N2, P2), where, the respective LSBs from both signatures are the same or otherwise identify the same queue.

In further embodiments, as described in more detail below with respect to the specially constructed hash key, at least some of the specific header information that is hashed with the specially constructed hash key to create the desired hash signature is also constructed, or “found” as the result of a process that is performed ancillary to the hash key construction process. Generally, the external nodes (N1 and N2 in FIGS. 2a and 2b) are fixed and cannot be changed. The respective port IDs that the uplink and downlink packets are received at, however, are local to the pipeline's system (NK in FIGS. 2a and 2b) and therefore can be specially selected to force header values that when hashed by the specially constructed hash key results in the same queue assignment in both directions.

With respect to the packet processing pipeline 303 of FIG. 3, as described above, which hash key to use for a particular packet is derived from the operation of the stage 305 of the pipeline 303 that performs packet classification and/or flow identification.

Here, as discussed above, packet classification or flow identification entails matching extracted packet header information (e.g., port and IP address of both the packet's source and destination) with an entry in a table 308 having multiple entries of looked for packet header content. According to one approach, the matching entry includes information that identifies the particular hash key to use for the packet having the corresponding header content which is then passed to the queue assignment stage 306.

In another approach, the entries in table 308 include information that describe the type of flow (e.g., pass through stateful bi-directional, modified stateful bi-directional, etc.) and the queue assignment stage 306 is designed to apply a particular key based on flow type. (e.g., the specially constructed key (Key_2) is used for modified stateful flow types and the symmetrical Toeplitz key (Key_1) is used for all other flow types). Note that the modified stateful flow includes a form of network address translation (NAT). Thus, the specially constructed key (Key_2) can be used to direct flows having numerically dissimilar content to a same processor that performs NAT on the flows.

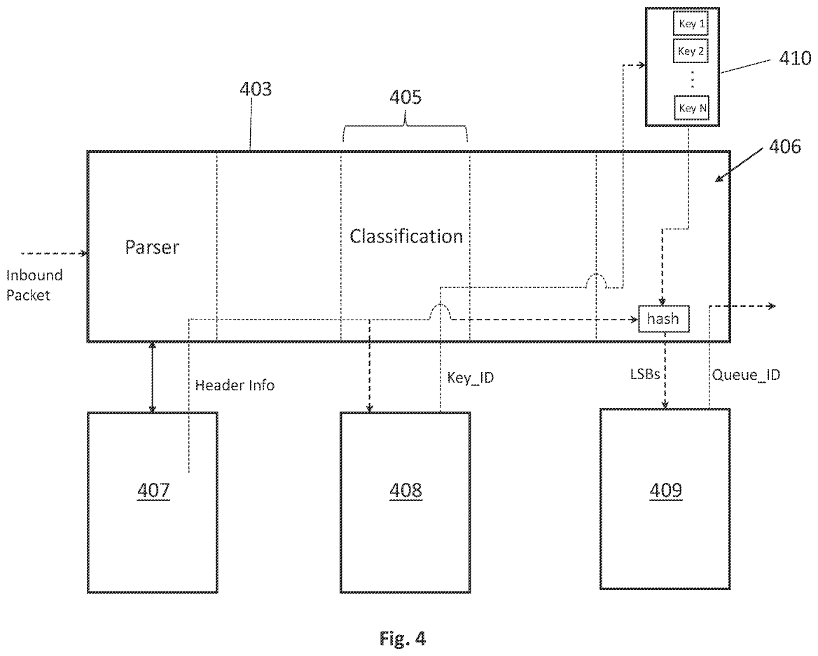

It is pertinent to point out that the teachings above can be applied to other scenarios, solutions and/or applications than the specific ones described just above. For example, in various implementations the pipeline can support the use of more than two different hash keys. FIG. 4 shows another pipeline embodiment where the queue assignment stage 406 can employ up to N different hash keys.

Here, the pipeline operates as described just above except that the Key ID (or flow description such as flow type) that is derived from packet classification is used as a lookup parameter into a table 410 having N different hash key entries. For each packet that is processed, the Key ID or Flow ID identifies one of these entries. The identified hash key is provided by the table 410 in response to the lookup and hashed with the packet's header information to generate the hash signature for queue assignment.

The pipeline 303/403 can be implemented by any combination of hardware and software. In the case where the pipeline 303, 403 is implemented with dedicated hardware (e.g., application specific (dedicated hardwire) logic circuitry, field programmable gate array (FPGA), etc.) each table 307/407, 308/408, 309/409, 410 can be implemented with memory that is coupled, one or more registers that are coupled to the pipeline 303/403 or some combination thereof.

In various embodiments, the pipeline's tables are configured, e.g., during bring-up of the system that the pipeline is integrated into (e.g., a computer system) and/or the plug-in/add-in card or module that the pipeline is integrated into. Specifically, the classification table 308, 408 can be configured (e.g., by low level software such as firmware, a device driver, operating system, a combination thereof, etc.) with information that correlates a specific hash key (e.g., a key identifier) to specific header information or set of header information so that packets having specific header content and/or belonging to flows of a particular type, are correlated to a specific hash key.

Likewise, the hash keys themselves (e.g., Key_1, Key_2, etc.) can be programmed by the software into the pipeline by being stored in memory and/or register space associated with the pipeline. Here, low level software can construct the specially constructed key(s) before the specially constructed key(s) are programmed into the pipeline. The construction of the specially constructed key(s) can include using and/or defining certain characteristics of certain flows (e.g., that are to have the specially constructed keys) that are variable options within the system the pipeline is configured within (e.g., port ID which is a numeric value that is locally determined in the system). For the pipeline of FIG. 4, memory and/or register space 410 is also programmed with information by low level software that includes the different hash keys used by the pipeline. The information can also include a respective hash key identifier that is correlated to each hash key.

Notably different pipelines can have different arrangements of pipeline stages and/or include other stages than those described above. For example, various pipeline implementations may merge the parser and classification stages, or, merge the classification and queue assignment stages. For example, various pipelines can include a stage that performs switching (e.g., Ethernet MAC address switching, multiprotocol label switching (MPLS), etc.) including layer 3 (e.g., internet protocol (IP)) switching.

In still other or combined implementations, which particular queue a packet is placed in by the queue assignment stage determines some network service for the packet other than a particular processor that will service the packet. For example, different queues may be established for different quality of service (QoS) treatment (e.g., longer or shorter propagation delays) and assignment to a particular queue (or set of queues) effects a particular QoS. For example, a number of queues may correspond to a same, first level of QoS treatment and a RSS key is applied to packets that are to be treated according to the first QoS level. By contrast, another queue may correspond to a second level of QoS treatment (e.g., real time high priority) and a specially constructed key is applied to packets that are to be treated according to the second level.

According to another example, some queues feed processors that perform layer 3 switching while another queue (or queues) feed processors that perform layer 2 switching. In this case, one hash key could be used for packets that are to be treated with layer 3 switching while another hash key could be used for packets that are to be treated with layer 2 switching.

In various embodiments the aforementioned queue assignment stage determines some system component other than a queue that a packet is to be directed to (in which case the queue assignment stage will have some other name). For example, such a stage could assign hardware packets to hardware exit ports, where, which exit port a packet is to be transmitted from depends on a hash of a key that is appropriate for that packet with information contained in the packet's header.

Any of the pipelines described above can be used, more generally, to assign packets based on their header information to various system components (e.g., queues, exit ports) according to various algorithms each effected with a respective hash key that is appropriate for the packets that are processed by the pipeline.

Further still, the teachings above can be applied not only to networking systems but to the networking function of, e.g., a computer system. For example, if the computer system is a large scale application server, the different processing cores each execute their own respective application software.

In this case, flows can terminate/originate at the computer rather than flow through the computer. Queue assignment determines which processing core will process a particular packet's payload (which, e.g., can be a client request that invokes a core's software application). Some applications may be instantiated on multiple cores allowing for receive side scaling with a symmetrical hash key. By contrast, other applications may be specific to a particular core which requires a specially crafted key for clients whose requesting packets have specific header content to force assignment of the packets to the particular core.

Although the Toeplitz hash function using a symmetrical hash key was specifically mentioned above, other hash keys can be used with the Toeplitz hash function (or other hash function) such as a predictable RSS-generated hash key as well as other keys based on an XOR hashing process, a cyclic redundancy check (CRC) hashing process, etc.

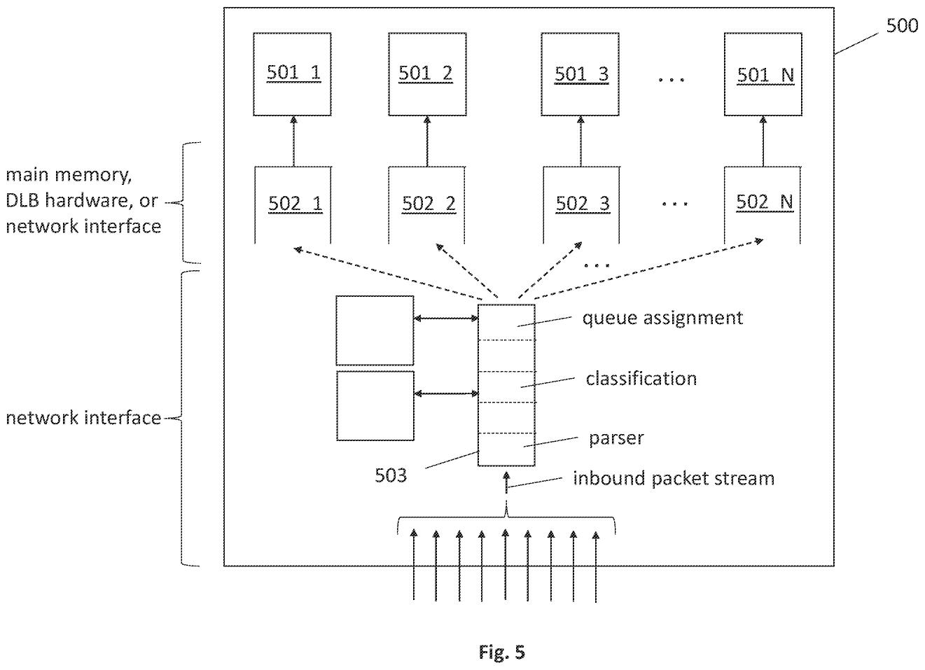

FIG. 5 shows a system 500 having multiple processing cores 501, a main memory and a network interface (such as a network interface card (NIC)). The improved pipeline 503 that is capable of applying different hash keys to different types of flows is integrated on the network interface. The queues 502 can be implemented in various locations depending on the architecture of the system. For example, the queues can be implemented with software executed by one or more of the processing cores 501 and are therefore deemed to be in main memory.

Alternatively, the queues can be located on a special hardware module such as a distributed load balancer (DLB) hardware module. According to one embodiment, the DLB hardware module is a peripheral like module (e.g., a PCIe card, an OAM module, etc.) that plugs into the system 500 and has the memory resources and queuing logic to place packets (or portions thereof) into the queues 502. In this case, note that the application of different hash keys to packets of different flow types for purposes of queue assignment can be performed by the circuitry on the DLB module rather than the pipeline 503 (e.g., the key ID or flow ID from the pipeline's classification is passed from the network interface to the DLB module for queue assignment, or, the DLB performs some kind of classification or flow identification).

Also, the queues could be integrated directly on the network interface.

FIG. 5 can also be used to describe a data center implementation where, e.g., the pipeline 503 is integrated on an infrastructure processing unit (IPU), orchestrator, or other function that has the networking intelligence to direct incoming packets with specific header information to, e.g., specific micro-service containers and/or instances. Here, micro-services can be “pay per usage” services in which customers pay, e.g., for the execution of specific software function calls made to specific application software programs. This is believed to be a more efficient model than one in which customers pay for entire applications (e.g., that execute on a full time basis for the customer). In combination or in the alternative, micro-services can be a collection of fine-grained software functions (e.g., single task/function per call/invocation) that are individually/separably callable/invokable by a remote customer/client. Kubernetes or K8 is a popular platform for scaling out “containers” of micro-service execution environments.

Here, for instance, the processing cores 501 can execute the micro-services and the pipeline 503, e.g., is responsible for directing certain packet flows to certain processing cores. Thus, the processing cores 501 can be integrated in a same computing system as the pipeline 503 and/or be integrated in one or more different computing systems where, e.g., a backbone network within the data center separates the cores 501 and the IPU having the pipeline 503.

Here, a specially constructed key can be used in the case of flows composed of numerically different header content that are to be directed to a same processor, e.g., a collaborative effort that involves multiple clients (having substantially different source header content) concurrently invoking a same micro-service or micro-service cluster that is instantiated on a particular processor. The processors 501 also need not perform the micro-services (another one or more processors not shown in FIG. 5 perform them), but for some reason the packets originating from the different clients are best processed for some specific networking function (e.g., a security function), e.g., that is stateful across all the clients, that is best processed by a same one of processors 501_1 through 501_N.

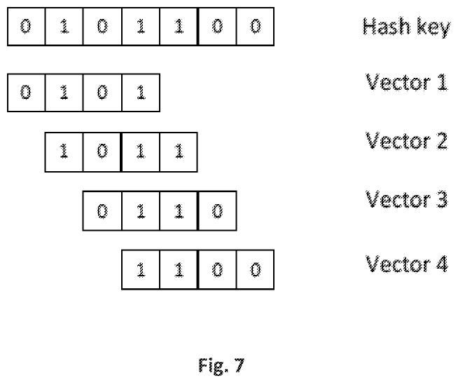

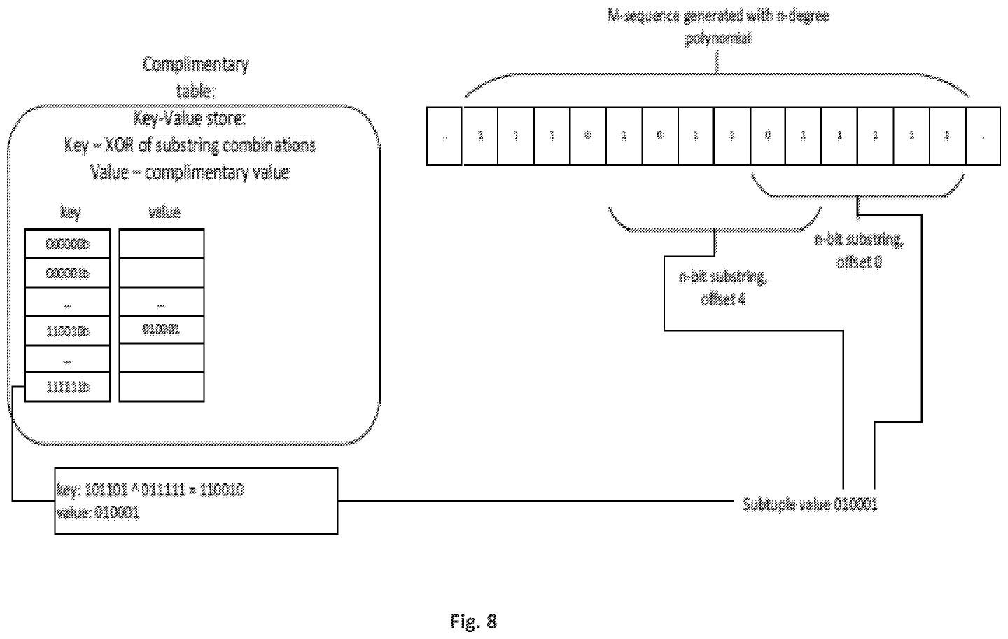

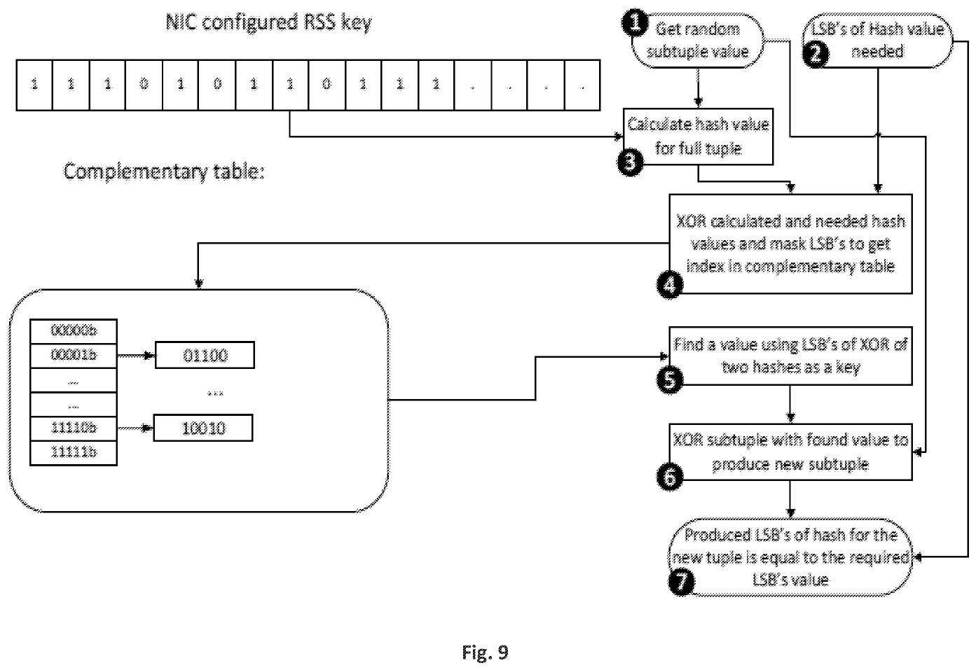

As discussion above, during bring-up of the network interface that the pipeline 503 is integrated upon, the specific key is constructed by executing a process consistent with FIG. 7 and FIG. 8 below. Header information is also specially selected, e.g., in view of available port IDs, by executing a process that is consistent with FIG. 9 below.

As discussed above, in various embodiments, only particular LSBs of the hash signature can be used as an index for selecting the queue for RSS. Thus, by controlling the input value for RSS hashing (by manipulating sub-tuple of the input n-tuple (e.g., where n-tuple includes n of source and/or destination of IP address, TCP/UDP port, ESP SPI, and/or MPLS label)), we can control the queue assignment and enable the RSS distribution to work in a predictable manner.

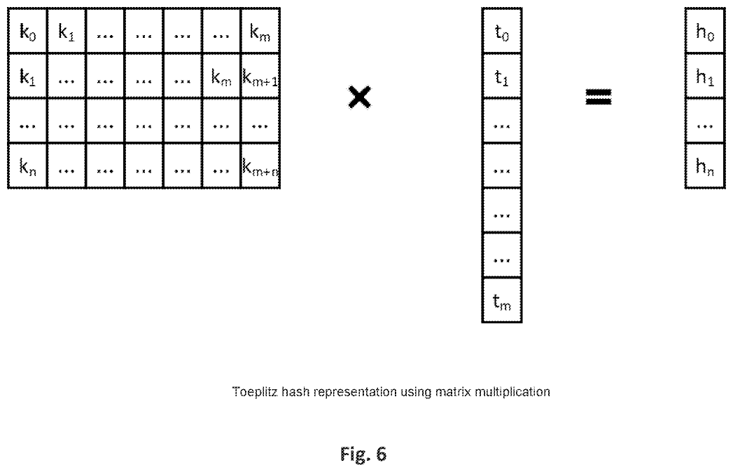

To compute a desired Toeplitz key, the following two procedures can be performed: 1) calculate the key with the given parameters; 2) calculate the complementary table of bits to be adjusted with the sub-tuple to produce the collision. A Toeplitz hash function can be viewed as a matrix multiplication with elements over Galois Field (2) as observed in FIG. 6.

Here, matrix K with elements {k0, . . . , km+n} over GF(2) represents the hash key, vector T with elements {t0, . . . , tm} over GF(2) represents a tuple, and vector H with elements {h0, . . . , hn} over GF(2) represents a hash value. The set of all tuples could be considered as an m-dimension vector space over GF(2), and the set of all hash values H as an n-dimension vector space over GF(2). In practice, resulting hash is a 32-bit value, so the vector space H has 32 dimensions (that is, n=32).

Thus, T and H form a group with respect to addition (in GF(2), that is modulo2 addition or just XOR) operation—<T, \hat{ }> and <H, \hat{ }>. Multiplication with matrix K can be treated as a linear map, that is a vector space homomorphism. So,

K*(t₁⊕t₂)=K*t₁⊕K*t₂=h₁⊕h₂ (1)

To produce the Toeplitz hash collision, a desired tuple t_{desired} should be found that produces a desired hash value h_{desired}. We can express:

h_{desired}=K*t_{desired} (2)

So, given original tuple t_{orig} and the corresponding hash value h_{orig}=K*t_{orig} we can express adjustment hash bits h_{adj} like:

h_{adj}=h_{desired}⊕h_{orig} (3)

and from (1) we can express the same for tuples using homomorphism:

t_{adj}=t_{desired}⊕t_{orig} (4)

so, we need to adjust t_{orig} with t_{adj} in order to produce the hash required collision:

t_{desired}=t_{adj}⊕t_{orig} (5)

From (1), (3), and (4):

K*t_{adj}=h_{orig}⊕h_{desired} (6)

In fact, usually matrix K is not a square matrix. It is not possible to find a K−1 in order to find t_{adj}, so we cannot revert the hash function. In other words, the hash function is a one-way function. We can find associations t_{adj}<->h_{adj} for each possible value h_{adj}. In general, this is an unsolvable task because of the size of t_{adj}, which is very big (for example, 96 bit for IPv4/TCP).

But it becomes possible if the key was built in a specific way.

From predictable RSS algorithm we need to calculate a hash function for all input t_{adj}. This is usually impossible due to size of the tuple that is generally bigger than the size of the hash. There are several requirements for the key to calculate full association table of t_{adj}<->h_{adj}: 1) it must be possible to calculate all n-bit values to get proper n-bit h_{adj} to find a required n-bit collision of the hash. That is, there should not be any non-computable h_{adj} values; 2) all variable bits of the t_{adj} must be grouped together, that is, there must be a single unfragmented (continuous) n-bit sub-tuple to calculate the required h_{adj}; 3) all n-bit h_{adj} values must be calculated from minimal set of t_{adj}— in other words from the bits belonging to the minimal subtuple.

To satisfy these requirements, the following approach can be used.

1. Every n-bit substring of the hash key can be expressed as a vector in n-dimensional vector space as also is shown in the predictable RSS algorithm. Toeplitz hash function represents itself as a linear combination of the key's n-bit substrings where every substring is multiplied by the corresponding bit of the tuple. Every input bit of the tuple has a corresponding n-bit substring of the hash key.

2. To generate any arbitrary n-bit value n of n-bit substrings (that is, vectors) of the hash key must be linear independent from each other that is, be a basis of the vector space. This means that it requires exactly n variable bit of the tuple to generate all possible n-bit hadj.

3. The grouping requirement needs that two nested basis vectors must share (n−1) bit and all n n-bit basis vectors must span in the hash key a bit sequence with length equal to 2*n−1 bit. FIG. 7 shows an example for n=4. All vectors are linearly independent from each other, and the two nested vectors share n−1 bit. That is, vectors can be calculated recursively:

Vₙ₊₁=f(Vₙ) (7)

4. There exists a cyclic vector v in V=GF(2\hat{ }n) for matrix A, meaning that {A0 v, Av, A2v, . . . , An−1v} is a basis of V, where A is the Frobenius companion matrix of some polynomial. This means we can express our f(x) as a multiplication of the companion matrix with some initial vector v to generate a basis of a vector space. Unfortunately, not every initial vector is applicable for an arbitrary companion matrix.

5. If Frobenius companion matrix A is companion of the monic polynomial irreducible over GF(2), then every initial non-zero vector v can be multiplied by A recursively spanning a basis of V. If this polynomial is also prime over GF(2), then the bit sequence in this case is called an m-sequence.

A complementary table can be composed of 2\hat{ }N entries, where N is the number of the resulting hash value's least significant bits to calculate collision on. Each entry maps an adjustment hash bit, which are used as a key with a corresponding adjustment bits of the

tuple, which are used as a value. For every non-zero n-bit value we calculate n-bit Toeplitz hash signature using a corresponding part of the hash key containing pre-generated m-sequence (with degree n polynomial) and insert in the complementary table a pair <hash_signature->n-bit_value> as shown in FIG. 8. The complementary table can then be used to find sub-tuples (variable part of the full tuple) that will lead to hash signature calculation in a way that LSB's of calculated signature will have required value. Complementary table has 2\hat{ }LSB key-val entries.

As shown in FIG. 9, to control queue assignment thereby making RSS distribution to work in a predictable manner, the following process can be followed: 1) Generate a tuple with a random sub-tuple; 2) Select a desired LSB value for the hash signature; 3) Calculate hash value for the given tuple; 4) Perform XOR with the desired LSB value and use the result to lookup in the complementary table; 5) Find a set of bits using LSBs of XOR of two hashes as a key; 6) XOR previously found bits with the sub-tuple bits to get the new value of the sub-tuple in a way that the hash signature of the full tuple will have the required least significant bits; 7) If the new value of the sub-tuple is already in use, repeat this procedure from step 1 until unused value of the sub-tuple is found.

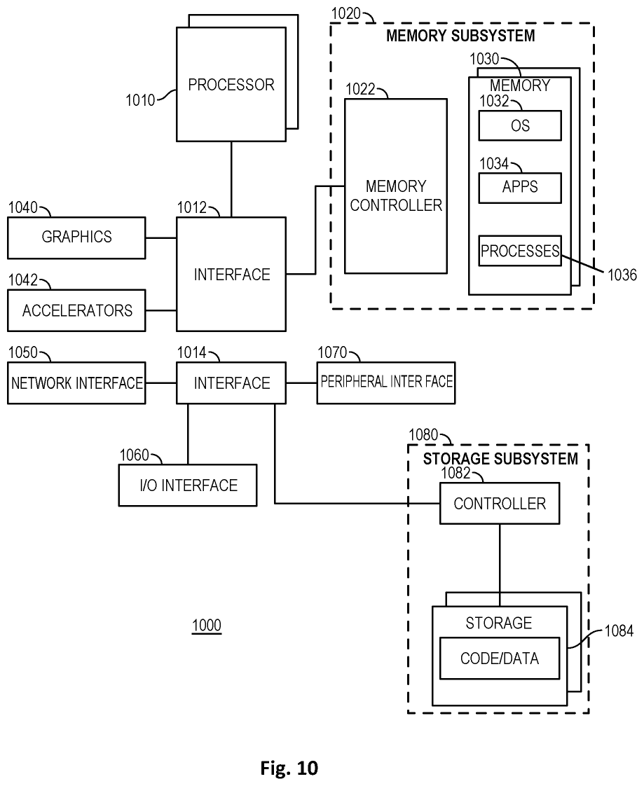

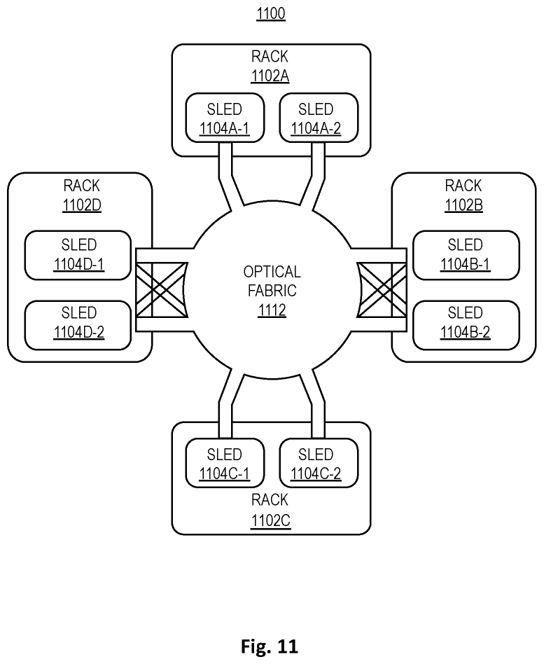

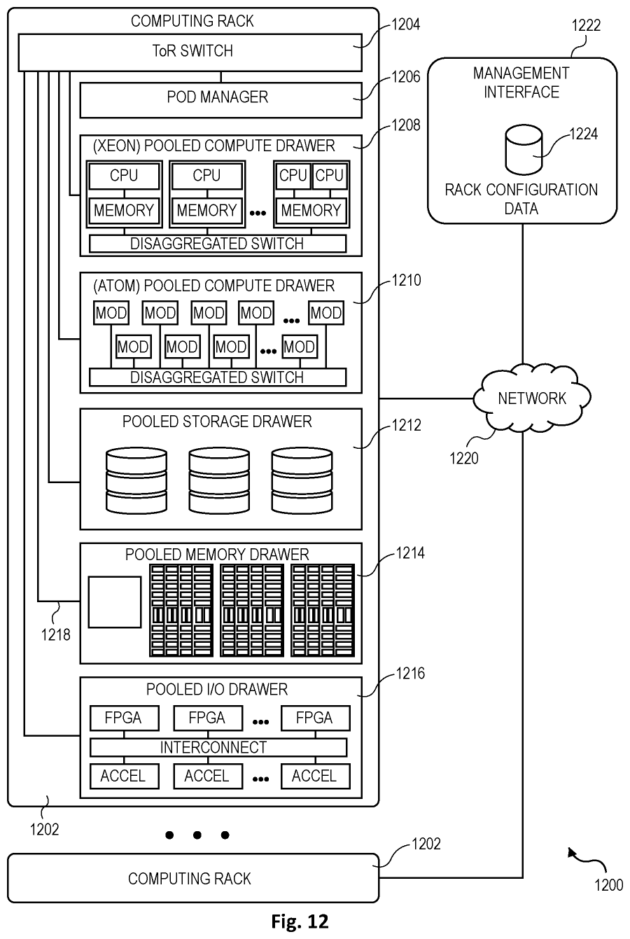

The following discussion concerning FIGS. 10, 11, and 12 are directed to systems, data centers and rack implementations, generally. FIG. 10 generally describes possible features of an electronic system that can include ingress queue and busyness metric calculation functionality as described above. FIG. 11 describes possible features of a data center that can include such electronic systems. FIG. 12 describes possible features of a rack having one or more such electronic systems.

FIG. 10 depicts an example system. System 1000 includes processor 1010, which provides processing, operation management, and execution of instructions for system 1000. Processor 1010 can include any type of microprocessor, central processing unit (CPU), graphics processing unit (GPU), processing core, or other processing hardware to provide processing for system 1000, or a combination of processors. Processor 1010 controls the overall operation of system 1000, and can be or include, one or more programmable general-purpose or special-purpose microprocessors, digital signal processors (DSPs), programmable controllers, application specific integrated circuits (ASICs), programmable logic devices (PLDs), or the like, or a combination of such devices.

Certain systems also perform networking functions (e.g., packet header processing functions such as, to name a few, next nodal hop lookup, priority/flow lookup with corresponding queue entry, etc.), as a side function, or, as a point of emphasis (e.g., a networking switch or router). Such systems can include one or more network processors to perform such networking functions (e.g., in a pipelined fashion or otherwise).

In one example, system 1000 includes interface 1012 coupled to processor 1010, which can represent a higher speed interface or a high throughput interface for system components that needs higher bandwidth connections, such as memory subsystem 1020 or graphics interface components 1040, or accelerators 1042. Interface 1012 represents an interface circuit, which can be a standalone component or integrated onto a processor die. Where present, graphics interface 1040 interfaces to graphics components for providing a visual display to a user of system 1000. In one example, graphics interface 1040 can drive a high definition (HD) display that provides an output to a user. High definition can refer to a display having a pixel density of approximately 100 PPI (pixels per inch) or greater and can include formats such as full HD (e.g., 1080p), retina displays, 4K (ultra-high definition or UHD), or others. In one example, the display can include a touchscreen display. In one example, graphics interface 1040 generates a display based on data stored in memory 1030 or based on operations executed by processor 1010 or both. In one example, graphics interface 1040 generates a display based on data stored in memory 1030 or based on operations executed by processor 1010 or both.

Accelerators 1042 can be a fixed function offload engine that can be accessed or used by a processor 1010. For example, an accelerator among accelerators 1042 can provide compression (DC) capability, cryptography services such as public key encryption (PKE), cipher, hash/authentication capabilities, decryption, or other capabilities or services. In some embodiments, in addition or alternatively, an accelerator among accelerators 1042 provides field select controller capabilities as described herein. In some cases, accelerators 1042 can be integrated into a CPU socket (e.g., a connector to a motherboard or circuit board that includes a CPU and provides an electrical interface with the CPU). For example, accelerators 1042 can include a single or multi-core processor, graphics processing unit, logical execution unit single or multi-level cache, functional units usable to independently execute programs or threads, application specific integrated circuits (ASICs), neural network processors (NNPs), “X” processing units (XPUs), programmable control logic circuitry, and programmable processing elements such as field programmable gate arrays (FPGAs). Accelerators 1042, processor cores, or graphics processing units can be made available for use by artificial intelligence (AI) or machine learning (ML) models. For example, the AI model can use or include any or a combination of a reinforcement learning scheme, Q-learning scheme, deep-Q learning, or Asynchronous Advantage Actor-Critic (A3C), convolutional neural network, recurrent convolutional neural network, or other AI or ML model. Multiple neural networks, processor cores, or graphics processing units can be made available for use by AI or ML models.

Memory subsystem 1020 represents the main memory of system 1000 and provides storage for code to be executed by processor 1010, or data values to be used in executing a routine. Memory subsystem 1020 can include one or more memory devices 1030 such as read-only memory (ROM), flash memory, volatile memory, or a combination of such devices. Memory 1030 stores and hosts, among other things, operating system (OS) 1032 to provide a software platform for execution of instructions in system 1000. Additionally, applications 1034 can execute on the software platform of OS 1032 from memory 1030. Applications 1034 represent programs that have their own operational logic to perform execution of one or more functions. Processes 1036 represent agents or routines that provide auxiliary functions to OS 1032 or one or more applications 1034 or a combination. OS 1032, applications 1034, and processes 1036 provide software functionality to provide functions for system 1000. In one example, memory subsystem 1020 includes memory controller 1022, which is a memory controller to generate and issue commands to memory 1030. It will be understood that memory controller 1022 could be a physical part of processor 1010 or a physical part of interface 1012. For example, memory controller 1022 can be an integrated memory controller, integrated onto a circuit with processor 1010. In some examples, a system on chip (SOC or SoC) combines into one SoC package one or more of: processors, graphics, memory, memory controller, and Input/Output (I/O) control logic circuitry.

A volatile memory is memory whose state (and therefore the data stored in it) is indeterminate if power is interrupted to the device. Dynamic volatile memory requires refreshing the data stored in the device to maintain state. One example of dynamic volatile memory incudes DRAM (Dynamic Random Access Memory), or some variant such as Synchronous DRAM (SDRAM). A memory subsystem as described herein may be compatible with a number of memory technologies, such as DDR3 (Double Data Rate version 3, original release by JEDEC (Joint Electronic Device Engineering Council) on Jun. 27, 2007). DDR4 (DDR version 4, initial specification published in September 2012 by JEDEC), DDR4E (DDR version 4), LPDDR3 (Low Power DDR version3, JESD209-3B, August 2013 by JEDEC), LPDDR4 (LPDDR version 4, JESD209-4, originally published by JEDEC in August 2014), WIO2 (Wide Input/Output version 2, JESD229-2 originally published by JEDEC in August 2014), HBM (High Bandwidth Memory), JESD235, originally published by JEDEC in October 2013, LPDDR5, HBM2 (HBM version 2), or others or combinations of memory technologies, and technologies based on derivatives or extensions of such specifications.

In various implementations, memory resources can be “pooled”. For example, the memory resources of memory modules installed on multiple cards, blades, systems, etc. (e.g., that are inserted into one or more racks) are made available as additional main memory capacity to CPUs and/or servers that need and/or request it. In such implementations, the primary purpose of the cards/blades/systems is to provide such additional main memory capacity. The cards/blades/systems are reachable to the CPUs/servers that use the memory resources through some kind of network infrastructure such as CXL, CAPI, etc.

The memory resources can also be tiered (different access times are attributed to different regions of memory), disaggregated (memory is a separate (e.g., rack pluggable) unit that is accessible to separate (e.g., rack pluggable) CPU units), and/or remote (e.g., memory is accessible over a network).

While not specifically illustrated, it will be understood that system 1000 can include one or more buses or bus systems between devices, such as a memory bus, a graphics bus, interface buses, or others. Buses or other signal lines can communicatively or electrically couple components together, or both communicatively and electrically couple the components. Buses can include physical communication lines, point-to-point connections, bridges, adapters, controllers, or other circuitry or a combination. Buses can include, for example, one or more of a system bus, a Peripheral Component Interconnect express (PCIe) bus, a HyperTransport or industry standard architecture (ISA) bus, a small computer system interface (SCSI) bus, Remote Direct Memory Access (RDMA), Internet Small Computer Systems Interface (iSCSI), NVM express (NVMe), Coherent Accelerator Interface (CXL), Coherent Accelerator Processor Interface (CAPI), Cache Coherent Interconnect for Accelerators (CCIX), Open Coherent Accelerator Processor (Open CAPI) or other specification developed by the Gen-z consortium, a universal serial bus (USB), or an Institute of Electrical and Electronics Engineers (IEEE) standard 1394 bus.

In one example, system 1000 includes interface 1014, which can be coupled to interface 1012. In one example, interface 1014 represents an interface circuit, which can include standalone components and integrated circuitry. In one example, multiple user interface components or peripheral components, or both, couple to interface 1014. Network interface 1050 provides system 1000 the ability to communicate with remote devices (e.g., servers or other computing devices) over one or more networks. Network interface 1050 can include an Ethernet adapter, wireless interconnection components, cellular network interconnection components, USB (universal serial bus), or other wired or wireless standards-based or proprietary interfaces. Network interface 1050 can transmit data to a remote device, which can include sending data stored in memory. Network interface 1050 can receive data from a remote device, which can include storing received data into memory. Various embodiments can be used in connection with network interface 1050, processor 1010, and memory subsystem 1020.

In one example, system 1000 includes one or more input/output (I/O) interface(s) 1060. I/O interface 1060 can include one or more interface components through which a user interacts with system 1000 (e.g., audio, alphanumeric, tactile/touch, or other interfacing). Peripheral interface 1070 can include any hardware interface not specifically mentioned above. Peripherals refer generally to devices that connect dependently to system 1000. A dependent connection is one where system 1000 provides the software platform or hardware platform or both on which operation executes, and with which a user interacts.

In one example, system 1000 includes storage subsystem 1080 to store data in a nonvolatile manner. In one example, in certain system implementations, at least certain components of storage 1080 can overlap with components of memory subsystem 1020. Storage subsystem 1080 includes storage device(s) 1084, which can be or include any conventional medium for storing large amounts of data in a nonvolatile manner, such as one or more magnetic, solid state, or optical based disks, or a combination. Storage 1084 holds code or instructions and data in a persistent state (e.g., the value is retained despite interruption of power to system 1000). Storage 1084 can be generically considered to be a “memory,” although memory 1030 is typically the executing or operating memory to provide instructions to processor 1010. Whereas storage 1084 is nonvolatile, memory 1030 can include volatile memory (e.g., the value or state of the data is indeterminate if power is interrupted to system 1000). In one example, storage subsystem 1080 includes controller 1082 to interface with storage 1084. In one example controller 1082 is a physical part of interface 1014 or processor 1010 or can include circuits in both processor 1010 and interface 1014.

A non-volatile memory (NVM) device is a memory whose state is determinate even if power is interrupted to the device. In one embodiment, the NVM device can comprise a block addressable memory device, such as NAND technologies, or more specifically, multi-threshold level NAND flash memory (for example, Single-Level Cell (“SLC”), Multi-Level Cell (“MLC”), Quad-Level Cell (“QLC”), Tri-Level Cell (“TLC”), or some other NAND). A NVM device can also comprise a byte-addressable write-in-place three dimensional cross point memory device, or other byte addressable write-in-place NVM device (also referred to as persistent memory), such as single or multi-level Phase Change Memory (PCM) or phase change memory with a switch (PCMS), NVM devices that use chalcogenide phase change material (for example, chalcogenide glass), resistive memory including metal oxide base, oxygen vacancy base, and Conductive Bridge Random Access Memory (CB-RAM), nanowire memory, ferroelectric random access memory (FeRAM, FRAM), magneto resistive random access memory (MRAM) that incorporates memristor technology, spin transfer torque (STT)-MRAM, a spintronic magnetic junction memory based device, a magnetic tunneling junction (MTJ) based device, a DW (Domain Wall) and SOT (Spin Orbit Transfer) based device, a thyristor based memory device, or a combination of any of the above, or other memory.

A power source (not depicted) provides power to the components of system 1000. More specifically, power source typically interfaces to one or multiple power supplies in system 1000 to provide power to the components of system 1000. In one example, the power supply includes an AC to DC (alternating current to direct current) adapter to plug into a wall outlet. Such AC power can be renewable energy (e.g., solar power) power source. In one example, power source includes a DC power source, such as an external AC to DC converter. In one example, power source or power supply includes wireless charging hardware to charge via proximity to a charging field. In one example, power source can include an internal battery, alternating current supply, motion-based power supply, solar power supply, or fuel cell source.

In an example, system 1000 can be implemented as a disaggregated computing system. For example, the system 1000 can be implemented with interconnected compute sleds of processors, memories, storages, network interfaces, and other components. High speed interconnects can be used such as PCIe, Ethernet, or optical interconnects (or a combination thereof). For example, the sleds can be designed according to any specifications promulgated by the Open Compute Project (OCP) or other disaggregated computing effort, which strives to modularize main architectural computer components into rack-pluggable components (e.g., a rack pluggable processing component, a rack pluggable memory component, a rack pluggable storage component, a rack pluggable accelerator component, etc.).

Although a computer is largely described by the above discussion of FIG. 10, other types of systems to which the above described invention can be applied and are also partially or wholly described by FIG. 10 are communication systems such as routers, switches, and base stations.

FIG. 11 depicts an example of a data center. Various embodiments can be used in or with the data center of FIG. 11. As shown in FIG. 11, data center 1100 may include an optical fabric 1112. Optical fabric 1112 may generally include a combination of optical signaling media (such as optical cabling) and optical switching infrastructure via which any particular sled in data center 1100 can send signals to (and receive signals from) the other sleds in data center 1100. However, optical, wireless, and/or electrical signals can be transmitted using fabric 1112. The signaling connectivity that optical fabric 1112 provides to any given sled may include connectivity both to other sleds in a same rack and sleds in other racks.

Data center 1100 includes four racks 1102A to 1102D and racks 1102A to 1102D house respective pairs of sleds 1104A-1 and 1104A-2, 1104B-1 and 1104B-2, 1104C-1 and 1104C-2, and 1104D-1 and 1104D-2. Thus, in this example, data center 1100 includes a total of eight sleds. Optical fabric 1112 can provide sled signaling connectivity with one or more of the seven other sleds. For example, via optical fabric 1112, sled 1104A-1 in rack 1102A may possess signaling connectivity with sled 1104A-2 in rack 1102A, as well as the six other sleds 1104B-1, 1104B-2, 1104C-1, 1104C-2, 1104D-1, and 1104D-2 that are distributed among the other racks 1102B, 1102C, and 1102D of data center 1100. The embodiments are not limited to this example. For example, fabric 1112 can provide optical and/or electrical signaling.

FIG. 12 depicts an environment 1200 that includes multiple computing racks 1202, each including a Top of Rack (ToR) switch 1204, a pod manager 1206, and a plurality of pooled system drawers. Generally, the pooled system drawers may include pooled compute drawers and pooled storage drawers to, e.g., effect a disaggregated computing system. Optionally, the pooled system drawers may also include pooled memory drawers and pooled Input/Output (I/O) drawers. In the illustrated embodiment the pooled system drawers include an INTEL® XEON® pooled computer drawer 1208, and INTEL® ATOM™ pooled compute drawer 1210, a pooled storage drawer 1212, a pooled memory drawer 1214, and a pooled I/O drawer 1216. Each of the pooled system drawers is connected to ToR switch 1204 via a high-speed link 1218, such as a 40 Gigabit/second (Gb/s) or 100 Gb/s Ethernet link or an 100+Gb/s Silicon Photonics (SiPh) optical link. In one embodiment high-speed link 1218 comprises an 600 Gb/s SiPh optical link.

Again, the drawers can be designed according to any specifications promulgated by the Open Compute Project (OCP) or other disaggregated computing effort, which strives to modularize main architectural computer components into rack-pluggable components (e.g., a rack pluggable processing component, a rack pluggable memory component, a rack pluggable storage component, a rack pluggable accelerator component, etc.).

Multiple of the computing racks 1200 may be interconnected via their ToR switches 1204 (e.g., to a pod-level switch or data center switch), as illustrated by connections to a network 1220. In some embodiments, groups of computing racks 1202 are managed as separate pods via pod manager(s) 1206. In one embodiment, a single pod manager is used to manage all of the racks in the pod. Alternatively, distributed pod managers may be used for pod management operations. RSD environment 1200 further includes a management interface 1222 that is used to manage various aspects of the RSD environment. This includes managing rack configuration, with corresponding parameters stored as rack configuration data 1224.

Any of the systems, data centers or racks discussed above, apart from being integrated in a typical data center, can also be implemented in other environments such as within a bay station, or other micro-data center, e.g., at the edge of a network.

Embodiments herein may be implemented in various types of computing, smart phones, tablets, personal computers, and networking equipment, such as switches, routers, racks, and blade servers such as those employed in a data center and/or server farm environment. The servers used in data centers and server farms comprise arrayed server configurations such as rack-based servers or blade servers. These servers are interconnected in communication via various network provisions, such as partitioning sets of servers into Local Area Networks (LANs) with appropriate switching and routing facilities between the LANs to form a private Intranet. For example, cloud hosting facilities may typically employ large data centers with a multitude of servers. A blade comprises a separate computing platform that is configured to perform server-type functions, that is, a “server on a card.” Accordingly, each blade includes components common to conventional servers, including a main printed circuit board (main board) providing internal wiring (e.g., buses) for coupling appropriate integrated circuits (ICs) and other components mounted to the board.

Various examples may be implemented using hardware elements, software elements, or a combination of both. In some examples, hardware elements may include devices, components, processors, microprocessors, circuits, circuit elements (e.g., transistors, resistors, capacitors, inductors, and so forth), integrated circuits, ASICs, PLDs, DSPs, FPGAs, memory units, logic gates, registers, semiconductor device, chips, microchips, chip sets, and so forth. In some examples, software elements may include software components, programs, applications, computer programs, application programs, system programs, machine programs, operating system software, middleware, firmware, software modules, routines, subroutines, functions, methods, procedures, software interfaces, APIs, instruction sets, computing code, computer code, code segments, computer code segments, words, values, symbols, or any combination thereof. Determining whether an example is implemented using hardware elements and/or software elements may vary in accordance with any number of factors, such as desired computational rate, power levels, heat tolerances, processing cycle budget, input data rates, output data rates, memory resources, data bus speeds, and other design or performance constraints, as desired for a given implementation.

Some examples may be implemented using or as an article of manufacture or at least one computer-readable medium. A computer-readable medium may include a non-transitory storage medium to store program code. In some examples, the non-transitory storage medium may include one or more types of computer-readable storage media capable of storing electronic data, including volatile memory or non-volatile memory, removable or non-removable memory, erasable or non-erasable memory, writeable or re-writeable memory, and so forth. In some examples, the program code implements various software elements, such as software components, programs, applications, computer programs, application programs, system programs, machine programs, operating system software, middleware, firmware, software modules, routines, subroutines, functions, methods, procedures, software interfaces, API, instruction sets, computing code, computer code, code segments, computer code segments, words, values, symbols, or any combination thereof.

According to some examples, a computer-readable medium may include a non-transitory storage medium to store or maintain instructions that when executed by a machine, computing device or system, cause the machine, computing device or system to perform methods and/or operations in accordance with the described examples. The instructions may include any suitable type of code, such as source code, compiled code, interpreted code, executable code, static code, dynamic code, and the like. The instructions may be implemented according to a predefined computer language, manner or syntax, for instructing a machine, computing device or system to perform a certain function. The instructions may be implemented using any suitable high-level, low-level, object-oriented, visual, compiled, and/or interpreted programming language.

To the extent any of the teachings above can be embodied in a semiconductor chip, a description of a circuit design of the semiconductor chip for eventual targeting toward a semiconductor manufacturing process can take the form of various formats such as a (e.g., VHDL or Verilog) register transfer level (RTL) circuit description, a gate level circuit description, a transistor level circuit description or mask description or various combinations thereof. Such circuit descriptions, sometimes referred to as “IP Cores”, are commonly embodied on one or more computer readable storage media (such as one or more CD-ROMs or other type of storage technology) and provided to and/or otherwise processed by and/or for a circuit design synthesis tool and/or mask generation tool. Such circuit descriptions may also be embedded with program code to be processed by a computer that implements the circuit design synthesis tool and/or mask generation tool.

The appearances of the phrase “one example” or “an example” are not necessarily all referring to the same example or embodiment. Any aspect described herein can be combined with any other aspect or similar aspect described herein, regardless of whether the aspects are described with respect to the same figure or element. Division, omission or inclusion of block functions depicted in the accompanying figures does not infer that the hardware components, circuits, software, and/or elements for implementing these functions would necessarily be divided, omitted, or included in embodiments.

Some examples may be described using the expression “coupled” and “connected” along with their derivatives. These terms are not necessarily intended as synonyms for each other. For example, descriptions using the terms “connected” and/or “coupled” may indicate that two or more elements are in direct physical or electrical contact with each other. The term “coupled,” however, may also mean that two or more elements are not in direct contact with each other, but yet still co-operate or interact with each other.

The terms “first,” “second,” and the like, herein do not denote any order, quantity, or importance, but rather are used to distinguish one element from another. The terms “a” and “an” herein do not denote a limitation of quantity, but rather denote the presence of at least one of the referenced items. The term “asserted” used herein with reference to a signal denote a state of the signal, in which the signal is active, and which can be achieved by applying any logic level either logic 0 or logic 1 to the signal. The terms “follow” or “after” can refer to immediately following or following after some other event or events. Other sequences may also be performed according to alternative embodiments. Furthermore, additional sequences may be added or removed depending on the particular applications. Any combination of changes can be used and one of ordinary skill in the art with the benefit of this disclosure would understand the many variations, modifications, and alternative embodiments thereof.

Disjunctive language such as the phrase “at least one of X, Y, or Z,” unless specifically stated otherwise, is otherwise understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present. Additionally, conjunctive language such as the phrase “at least one of X, Y, and Z,” unless specifically stated otherwise, should also be understood to mean X, Y, Z, or any combination thereof, including “X, Y, and/or Z.”

1. An apparatus, comprising:
a queue assignment circuitry comprising first circuitry to select amongst multiple hash keys and second circuitry to hash content of a packet's header with a selected one of the hash keys.

2. The apparatus of claim 1 wherein the first circuitry and the second circuitry are within a same stage of a packet processing pipeline.

3. The apparatus of claim 2 wherein the stage is to assign packets to queues.

4. The apparatus of claim 1 wherein one of the hash keys is to implement receive side scaling so that packets from multiple flows are spread across multiple queues.

5. The apparatus of claim 1 wherein the queue assignment circuitry is integrated with circuitry of a packet processing pipeline that comprises a stage to generate an identifier of one of the hash keys from the packet's classification.

6. The apparatus of claim 1 wherein the queue assignment circuitry is integrated with circuitry of a packet processing pipeline that is to identify a type of flow of a packet from the packet's classification, where, which of the multiple keys is selected by the first circuitry is based on the packet's type of flow.

7. The apparatus of claim 1 wherein a first of the hash keys is to implement receive side scaling and a second of the hash keys is to direct packets having different header values to a same queue, the same queue to feed a processor that is to perform network address translation on the packets having the different header values.

8. The apparatus of claim 7 wherein the queue assignment circuitry is integrated with circuitry of a packet processing pipeline and the second hash key is specially constructed for the pipeline.

9. A system, comprising:
a plurality of processing cores;
memory to implement a plurality of queues, wherein, specific ones of the processing cores are fed with packets from specific ones of the queues;
a packet processing pipeline comprising first circuitry to select amongst multiple hash keys and second circuitry to hash content of a packet's header with a selected one of the hash keys, wherein, one of the queues is to be identified for placement of the packet from a hash signature generated by the second circuitry.

10. The system of claim 9 wherein one of the hash keys is to implement receive side scaling so that packets from multiple flows are spread across multiple ones of the queues.

11. The system of claim 10 wherein the pipeline is to generate an identifier of one of the hash keys from the packet's classification.

12. The system of claim 9 wherein the pipeline is to identify a type of flow of a packet from the packet's classification, where, which of the multiple keys is selected by the first circuitry is based on the packet's type of flow.

13. The system of claim 9 wherein a first of the hash keys is to implement receive side scaling and a second of the hash keys is to direct packets having different header content to a same queue.

14. The system of claim 13 wherein the second hash key is specially constructed by the computing system for the pipeline.

15. The system of claim 9 wherein one of the hash keys is used for packets belonging to a pass-through stateful bi-directional flow and another of the hash keys is used for packets belonging to a modified stateful bi-directional flow.

16. A data center, comprising:
a plurality of computing systems;
one or more networks to which the plurality of computing systems are coupled, the one or more networks comprising a network node, the node to handle different flows of packets that are sent to and/or from the plurality of computing systems, the different flows comprising unidirectional flows, pass-through stateful bi-directional flows and modified stateful bi-directional flows, the node comprising circuitry to apply a first hash key for the unidirectional flows and the pass-through stateful bi-directional flows, and, apply a second hash key for the modified stateful bi-directional flows.

17. The data center of claim 16 wherein the first hash key is a Toeplitz hash key and the second hash key was specially constructed for the node.

18. The data center of claim 16 wherein the node comprises a packet processing pipeline that classifies the packets, the packet processing pipeline to determine when the first hash key is to be applied to packet and when the second hash key is to be applied to a packet.

19. The data center of claim 18 wherein the packet processing pipeline is integrated on a network interface of the node.

20. The data center of claim 19 wherein the network interface is a network interface card.

21. A machine readable storage medium containing program code that when processed by one or more processors causes the one or more processors to perform a method, comprising:
configuring a packet processing pipeline with multiple hash keys, the multiple hash keys to be respectively applied to respective header information of respective packets of respective flows that are to be processed by the packet processing pipeline.
